(19) United States
(12) Patent Application Publication
(10) Pub. No.: US 2004/0200688 A1
(43) Pub. Date: Oct. 14, 2004

(54) Roller track and guidance system

(76) Inventor: Lawrence Sorgi, Marblehead, MA (US)

Correspondence Address: NIXON PEABODY, LLP, 401 9TH STREET, NW, SUITE 900, WASHINGTON, DC, 20004-2128, US

(21) Appl. No.: 10/170,893

(22) Filed: Jun. 13, 2002

(51) Int. Cl. B65G 13/00

(52) U.S. Cl. 193/37

(57) ABSTRACT

Described is an object transport system that includes a plurality of roller tracks and roller guides. The roller tracks each include a plurality of rollers. Each roller track includes a keyway capable of receiving a key or interlocking component included in a roller track guide. The guide attaches to one side of the roller track. When the guide and roller track are interlocked, the roller track is perpendicular to the one side of the roller track to assist in controlling the movement of objects on the rollers of the roller track. The system includes pairs of roller tracks arranged such that for an n-pair arrangement of roller tracks, n+1 guides are used.

### BACKGROUND

1. Technical Field

This application generally relates to the movement of objects, and more particularly to systems and methods for controlling the direction and movement of objects.

2. Description of Related Art

Objects, such as containers, boxes, and the like, may be transported within a storage location, such as within a warehouse. To facilitate movement of the objects, roller tracks may be used. A roller track may include a plurality of cylindrical rollers. An object may be placed on the rollers of one or more roller tracks and the cylindrical or circular movement of each of the rollers assists in conveying the object to a target location.

One problem that may be encountered when using the roller tracks is that an object on the rollers may not stay within the side boundaries defined by the one or more roller tracks. The objects may roll off the tracks, for example, causing damage to the object being transported or any goods within a container being transported on the rollers. Conveyance or transport systems that may include roller tracks may occupy a large amount of space within a warehouse. Also, such systems may also be difficult to assemble and disassemble if needed in a particular location on a temporary basis.

Thus, it may be desirable to have an efficient way of transporting goods to control the movement and direction of the objects being transported. Additionally, it may be desirable that such techniques utilize components that are easily assembled and disassembled, and also that the amount of physical space occupied by the transport or conveyance system be as small as possible.

### SUMMARY OF THE INVENTION

In accordance with one aspect of the invention is an apparatus for transporting objects comprising: at least one roller track having a channel on an external face; and at least one roller track guide having a key portion that is of a shape capable of being received by said channel when said roller track guide is inserted into said channel in a direction parallel to said channel.

In accordance with another aspect of the invention is an apparatus for transporting rows of objects comprising: a plurality of roller tracks; and a plurality of roller track guides attached to said roller tracks such that for “n” rows of objects, said apparatus consists of “n+1” roller track guides.

In accordance with yet another aspect of the invention is a method of building an apparatus for transporting “n” rows of objects comprising: inserting at least one roller track guide into a channel included in a face of a roller track, each of said “n” rows having at least one corresponding roller track; and arranging a plurality of roller tracks and roller track guides using “n+1” roller track guides such that each roller track guide that is not located at an end of said arrangement is used as a guide for rows on both sides of said guide.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1A is an example of an embodiment of a roller track;

FIG. 1B is an example of an embodiment of a nylon carrier used in the roller track of FIG. 1A;

FIG. 1C is an example of an embodiment of a roller than may be included in the roller track of FIG. 1A;

FIG. 2 is an example of an embodiment of a profile view of a roller track guide;

FIG. 3 is an example of an embodiment of an assembled single roller track of FIG. 1A and roller track guide of FIG. 2;

FIG. 4A is an example of a front view of a system of roller tracks and guides of FIG. 203;

FIG. 4B is an example of a front view of another system arrangement of roller tracks and guide of FIG. 3;

FIG. 5 is an example of an angled view of a system of roller tracks and guides included in a vertical post and horizontal support assembly;

FIG. 6 is an example of an embodiment of a roller track and mounting bracket;

FIG. 7 is an example of an embodiment of a roller track and mounting bracket secured to a horizontal pipe included in a support structure of FIG. 5; and

FIG. 8 is an example of a top view of the structure of FIG. 5.

### DETAILED DESCRIPTION OF EMBODIMENT(S)

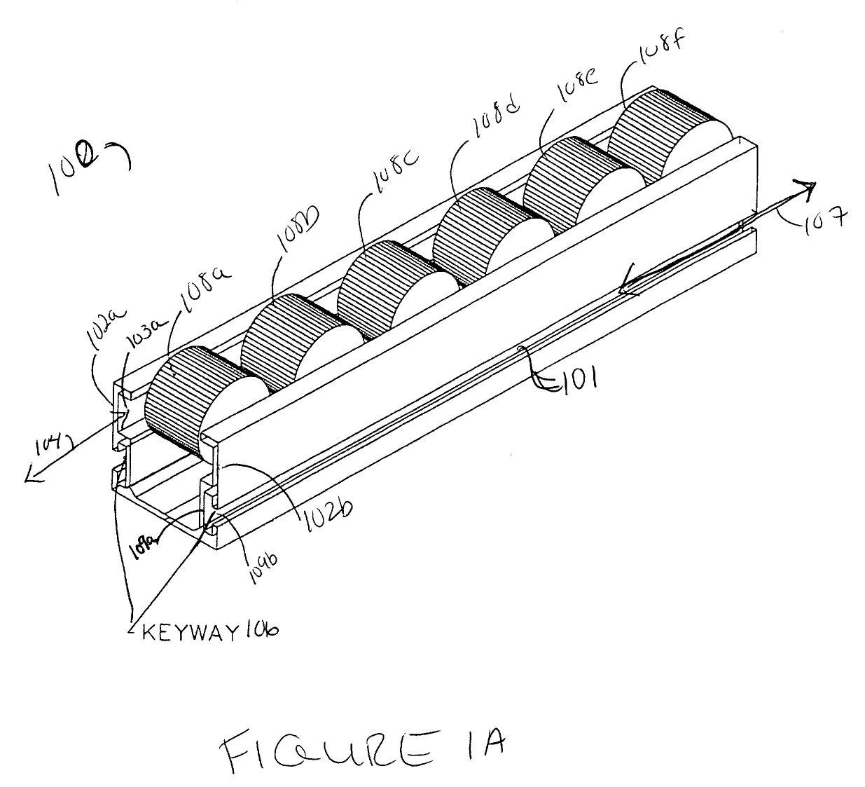

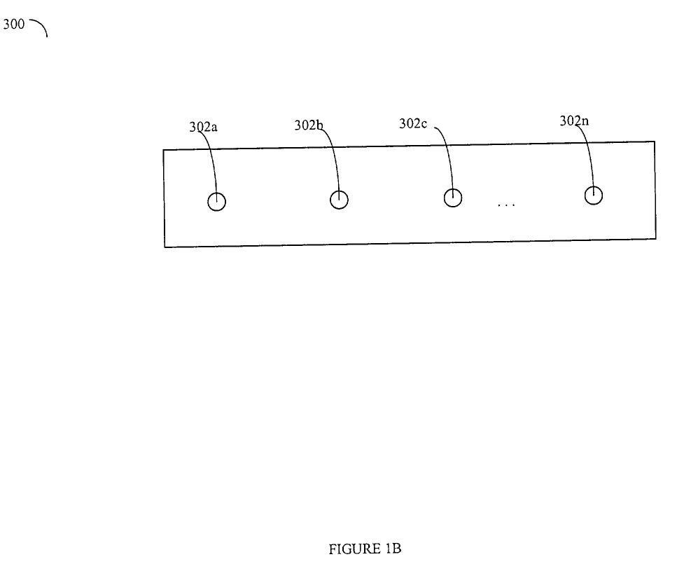

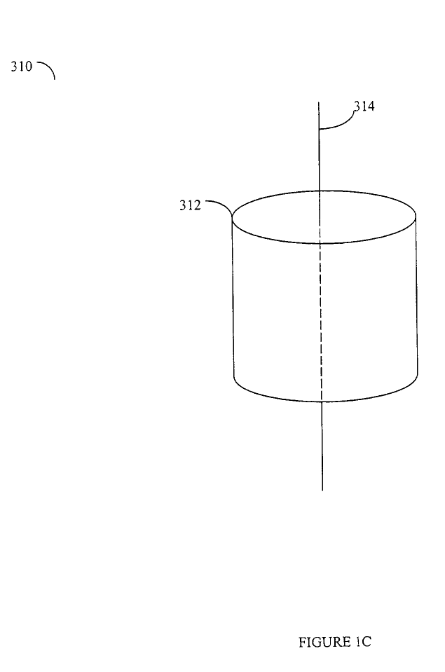

Referring now to FIG. 1A, shown is an example of an embodiment of a roller track 100. The roller track may include an upper portion having a first side 102a and a second side 102b. The roller track 100 may include a plurality of rollers 108a-108f secured in the upper portion. Each of the rollers 108a-108f may have an axle through the middle of the roller that is retained in a nylon carrier 103a included on the inner surfaces of the sides 102a and 102b facing toward the rollers. The axle included in each of the rollers may be made of a material such as steel. The nylon carrier at each of the inner surfaces may include a hole where the outer ends of each axle meets the carrier to receive the axle. Such an arrangement of the nylon carriers receiving the ends of each axle provides for retaining each roller in a relatively stable horizontal position while permitting the roller to move freely in a circular motion of rotation about the axis of the axle. The axle may be at approximately a perpendicular position relative to the sides 102a and 102b. The nylon carriers are described in more detail in following paragraphs.

The roller track, excluding the roller, may be made of extruded aluminum and may also be formed, for example, by rolling steel. The rollers 108a-108f may be made of a nylon material.

The roller track 100 may also include a keyway 106 for receiving a key described elsewhere herein in connection with a roller track guide. This embodiment of the roller track includes a keyway on each side of the bottom portion of the roller track 100 although, as described in more detail elsewhere herein, when assembled in a system, one or none of the keyways may be utilized.

The keyway 106 provides an opening for receiving and securing a key inserted along the direction of the arrow 107 in a side of the roller track channel 101. The keyway in this example includes an inner portion 109a that may be rectangular in shape having a side of a height greater than that of a narrower outer portion 109b forming an opening where the keyway meets the side of the roller track, such as 102b. The inner portion 109a has an opening in its outer side forming the narrower outer portion 109b. The inner portion 109a leading to the open and narrower outer portion 109b form the keyway 106 in the channel 101 along a side of the roller track 100.

It should be noted that other embodiments may include a varying number of rollers. An embodiment may also utilize other techniques in connection with securing the rollers within the roller track while allowing the rollers to move in a circular motion around a generally stationary axis through its center as described above in connection with FIG. 1A.

Referring now to FIG. 1B, shown is an example of an embodiment of a nylon carrier 300. The nylon carrier 300 may include holes or openings 302a-302n. Each of the holes 302a may receive one end of an axle of one of the rollers. Referring back to FIG. 1A, the nylon carrier 300 may be inserted by sliding the nylon carrier into a channel 103a along the direction of the arrow 104. The channel 103a may be located in the upper portion of the roller track 100 on the inner side walls of the upper portion of the roller track 100. A nylon carrier may be inserted into each of the channels 103a in both the left and right sides upper portion of the roller track 100. The rollers may then be placed into the roller track such that they are held in a relatively stationary position with respect to movement in the horizontal and vertical directions. However, as also described herein, the rollers are secured such that they may move in a relatively circular motion about a center axis though the center of the roller.

Referring now to FIG. 1C, shown is an example of an embodiment of a roller. The roller 312 includes an axle 314 approximately through its center. The ends of 314 may be in contact and received by holes included in the nylon carriers inserted into the roller track. the roller 312 is free to spin in a circular motion about the axle 314.

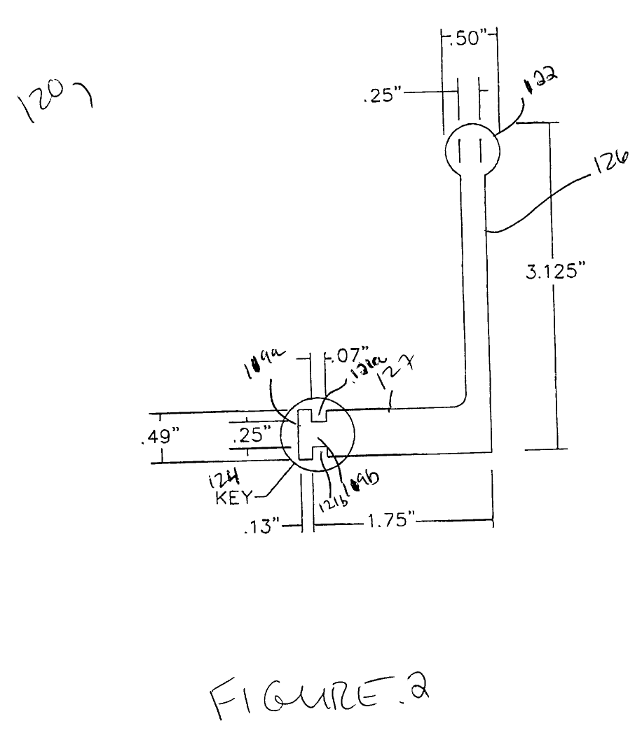

Referring now to FIG. 2, shown is an example of a side view of a roller track guide 120. The roller track guide 120 may include a key portion 124 shaped such that it is able to be received by the keyway 106 described in connection with the roller track 100 of FIG. 1A. In particular, the portion 119a fits into, and is received by, portion 109a of the keyway 106. Portion 119b fits into, and is received by, portion 109b of the keyway 106. The roller track guide may also include a top curved portion 122, a side wall 126, and a bottom portion 127. The roller track guide 122 may be manufactured as a one piece unit made of an extruded plastic, such as UHMWPE (Ultrahigh molecular weight polyethylene). The guide may also be made of other materials such as PVC, nylon, Delrin and extruded aluminum or other materials known to those of ordinary skill in the art. In this embodiment, the key portion 124 may be formed from a portion of the bottom 127 having cutouts 121a and 121b formed, respectively, in the top and bottom surfaces of 127 at approximately the same distance from the outside wall of 119a.

In one embodiment, the height of the side wall 126 and the top curved portion 122 in combination may be approximately 3.125 inches. The diameter of the top curved portion may be about 0.50 inches. The thickness of the profile view of the side wall 126 may be approximately 0.25 inches. The height of the larger inner portion 119a may be approximately 0.49 inches with a width of approximately 0.13 inches. The height of the narrower outer portion 119b may be approximately 0.25 inches with a width of approximately 0.07 inches. The bottom portion 127 spanning from the outer wall of the inner portion 119a may be approximately 1.75 inches having a thickness of approximately 0.49 inches.

It should be note that other embodiments may use different measurements other than as described herein in connection with the roller track guide. The particular dimensions described herein should not be construed as a limitation of the many different combinations of relative sizes that may be included in an embodiment.

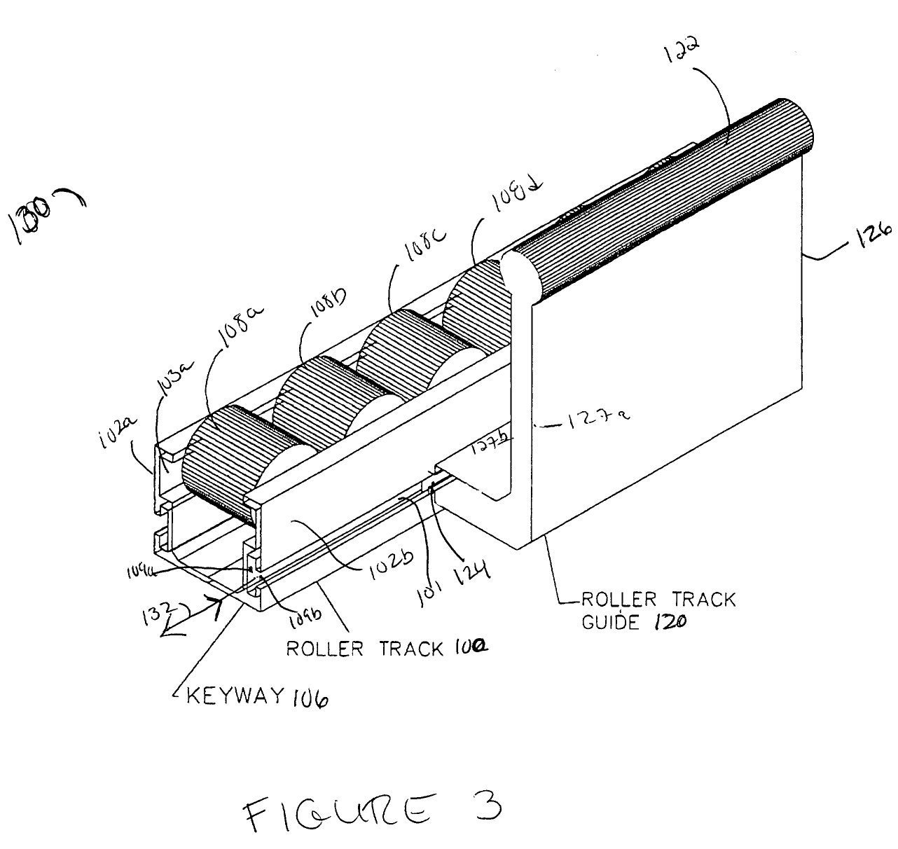

Referring now to FIG. 3, shown is an example 130 of an embodiment of an assembled single roller track of FIG. 1A and roller track guide of FIG. 2. In particular, the roller track guide 120 may be inserted into the roller track 100 by sliding the key of the roller track guide into the keyway 106 along the length of one side of the roller track channel 101 along the direction of the arrows 132. The keyway 106 receives the key 124 and is secured within the keyway 106 due to the outer narrower portion 109b which is narrower relative to the larger inner portion 109a of the keyway 106. The arrangement and fitting of the roller track 100 and the roller track guide 20120 permit the roller track guide 120 to move freely along the direction of the arrow 132 while being secured to the roller track. The key 124 and the keyway 106 form a interlock feature to connect the guide and the roller track. This interlock feature provides for an easy and secure assembly and disassembly of the roller tracks and roller track guide arrangement.

The roller track guide 120 may extruded from a metal, such as aluminum, or plastic. In this embodiment, the guide 120 is a solid extrusion. A single guide may be formed by partitioning a larger solid extrusion that is manufactured as a single unit. The larger solid extrusion may be divided into a plurality of smaller portions in which each smaller portion may be used as a guide. Each smaller portion may have a size that varies in accordance with the size of a guide necessary for moving, transporting, and the like particular objects.

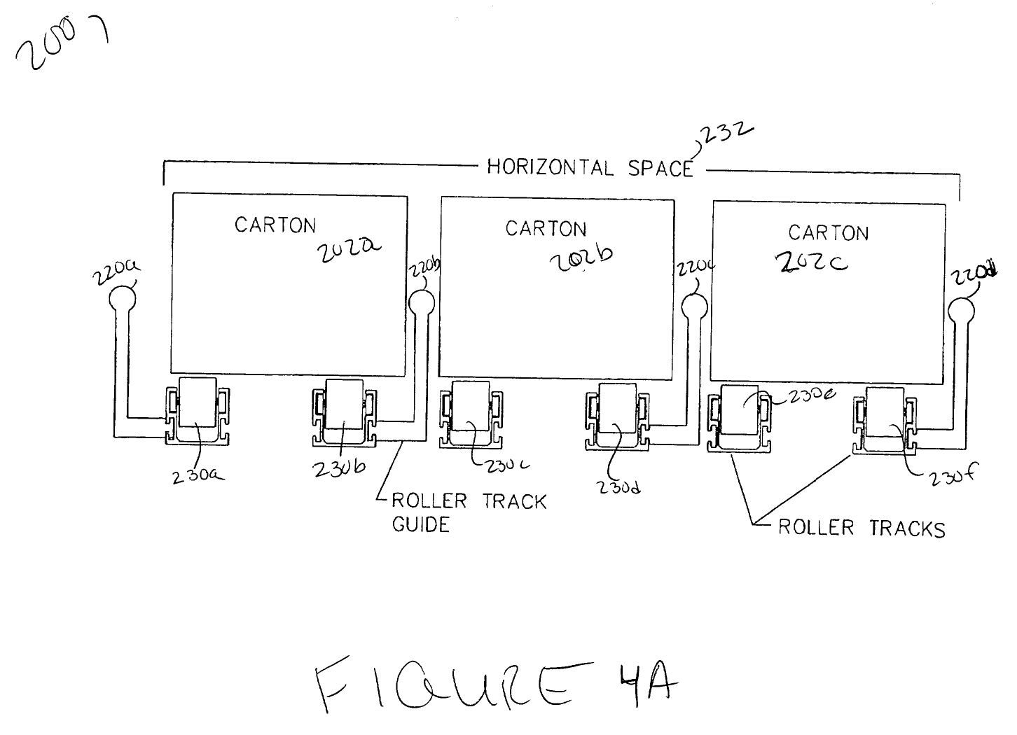

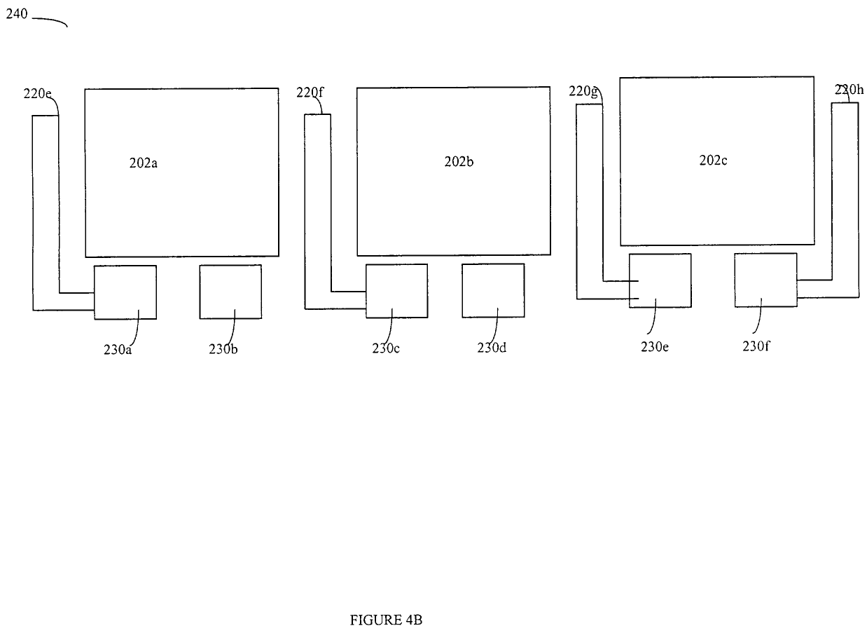

Referring now to FIG. 4A, shown is an example of a system 200 of roller tracks and roller track guides. The arrangement 200, as shown from a front profile view, includes a plurality of roller track guides 220a-220d and roller tracks 230a-230f. The arrangement 200 utilizes “n+1” roller track guides in connection with assisting the flow of “n” rows or racks of objects, such as cartons 202a-202c. Each inner row and one of the end rows, such as 202b and 202c respectively, has a corresponding pair of roller tracks in which a roller track guide, such as 220c, is secured in a first roller track, such as 230d, of the pair, and a second roller track, such as 230c, does not have an associated guide. The remaining other end row, such as 202a, has a corresponding pair of roller tracks in which a first roller track guide, such as 220b, is secured in a first roller track, such as 230b, of the pair, and a second roller track guide, such as 220a, is secured in the second roller track, such as 230a, of the pair. In the foregoing arrangement, each of the inner roller track guides may serve as a guide for two carton rows.

Referring now to FIG. 4B, shown is an example of another arrangement 240 of roller tracks and roller track guides. It should be noted that the arrangement of roller tracks and roller track guides may be such that the rightmost carton row 202c, rather than the leftmost carton row 202a, includes two roller tracks and two roller track guides such that each of the two roller track guides is inserted into one of the two roller tracks using the key and keyway interlock feature. In this example arrangement, each of the center carton row 202b and the leftmost carton row 202a may have a roller guide secured in the leftmost roller track, such as 230c, rather than the rightmost roller track, such as 230d, as shown in FIG. 4A. In FIG. 4B, elements 220e-h are roller track guides.

The guides, such as 220a-220d and 220e-h, may serve as guides for controlling the direction of the cartons while the movement of the cartons is facilitated by the rollers included in the roller tracks. In this example, the roller track and guidance system for carton flow racks assists in the flow of cartons in a straight path. The foregoing arrangements, such as in FIGS. 4A and 4B, decrease horizontal space by having a single guide for each pair of roller tracks except for one end pair of roller tracks having two associated guides as described above. The arrangement of roller tracks and roller track guides which seeks to use as few guides as possible may be a desirable feature, for example, to provide for efficient utilization of warehouse storage space.

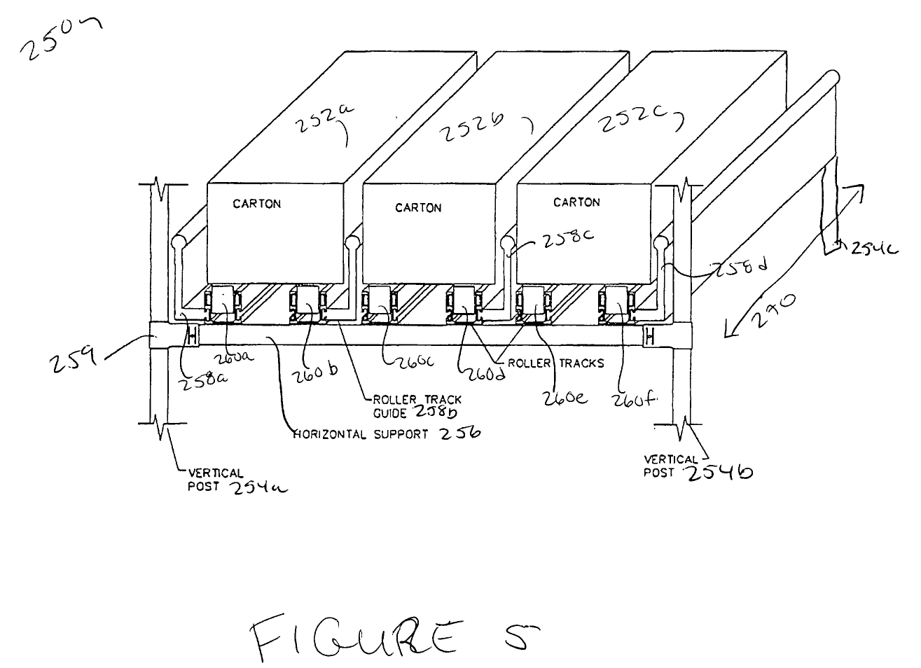

Referring now to FIG. 5, shown is another view and arrangement 250 of roller tracks and roller track guides. The perspective is at an angle view rather than the profile view of FIG. 4A. Additionally, in this arrangement 250, the roller tracks and roller track guides are contained within vertical posts and horizontal support structures. The vertical posts 254a-254c raise the roller tracks and guide system a vertical distance off the floor or other surface. The roller tracks and guides rest upon a surface of a horizontal support shelf or surface that may be mounted and secured on the vertical posts. The vertical posts and horizontal support may be made of any one of a variety of different materials including, for example, metal or other material. The roller tracks and guides may be affixed to the horizontal surface. In one embodiment, the horizontal support structure and the vertical posts may be formed by pipes or tubular-shaped components held together by mounting brackets.

When a force is exerted upon a container causing it to move in a direction along the arrow 270, the rollers are rotated to facilitate movement of the cartons in the direction of exertion while also controlling the direction of movement of the container.

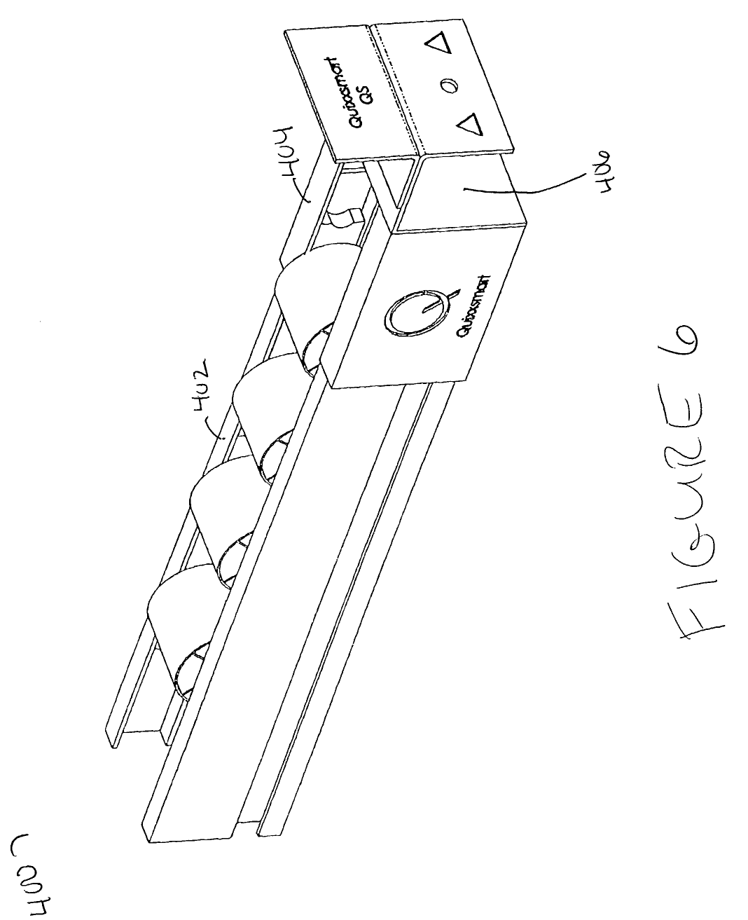

Referring now to FIG. 6, shown is an example 400 of a roller track 402 and an associated mounting bracket 404 that may be used in securing roller tracks included in the arrangement 250. In this example, the roller track may be inserted into an opening of the bracket 404. The bracket 404 includes a 3 sided structure forming opening 406. It should be noted that an embodiment may secure a bracket 404 to the track 402, for example, by having a through hole in the bracket with a mated hole or holes included in the track 402. The holes may be included in the underside of the bracket 404. The track 402 may be secured to the bracket 404 using, for example, a bolt, screw, or rivet.

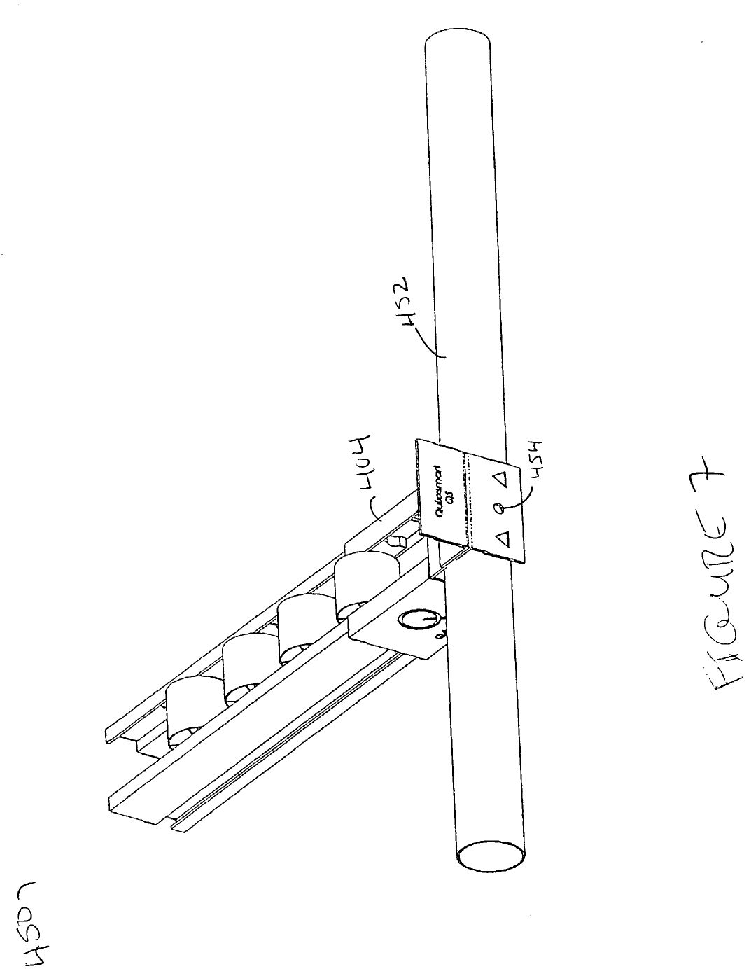

Referring now to FIG. 7, shown is an example 450 of the roller track 402 with bracket 404 mounted on a pipe or tubular component 452 that may be included as part of the horizontal support shown in FIG. 5. The bracket 454 has its opening 406 engage the pipe 452. The bracket may be mounted or secured to the pipe 452 using a screw, for example, inserted in opening 454 and through mated holes also included in the pipe 452. Another bracket may be used at the other end of the roller track to similarly secure the track to another pipe running parallel to the pipe shown 452 when assembled in a structure as shown in 250.

Referring back to FIG. 5 and arrangement 250, in one embodiment, the support structure to which the roller tracks are mounted may include 2 horizontal support pipes facing parallel to one another such that the roller tracks are mounted perpendicular to the horizontal pipes at each end of the roller tracks. Each of these horizontal support pipes may be connected to vertical posts at each corner. A corner bracket or connector 259 may be used to receive ends of each of the horizontal pipes in tubular or pipe openings or cylindrical sleeves in the vertical posts. The connector 259 may also include a ring-like opening or cylindrical sleeve into which a corner vertical post is inserted and passes through. Alternatively, the connector and vertical post may be a single piece unit. The pipes and brackets may be made from any one or more of a variety of different materials such as metal, plastic, and the like.

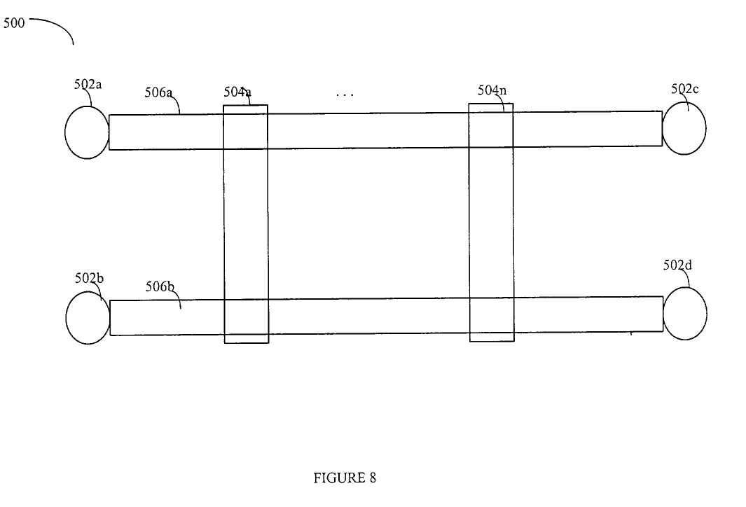

Referring now to FIG. 8, shown is an example 500 of a top view of the arrangement of 250 of FIG. 5. The example 500 includes a plurality of roller tracks and brackets 504a-504n mounted on two horizontal pipes 506a and 506b. The pipes 506a and 506b may be received by openings included in vertical posts 502a-502d.

It should be noted that other embodiments may include other support and mounting systems and structures used in connection with the roller track and roller track guide with the interlocking features described herein.

The foregoing provides a flexible arrangement of the roller track and roller track guide components such that a varying number of roller tracks and roller track guides may be included in an arrangement in accordance with a desired number of rows of containers. The interlock feature of the key of the roller track guide sliding into the keyway along the length of a side channel of the roller track provides for easy assembly and disassembly of components.

While the invention has been disclosed in connection with preferred embodiments shown and described in detail, their modifications and improvements thereon will become readily apparent to those skilled in the art. Accordingly, the spirit and scope of the present invention should be limited only by the following claims.

1. An apparatus for transporting objects comprising:
at least one roller track having a channel on an external face, wherein said channel is located within a bottom half of said roller track; and
at least one roller track guide having a key portion that is of a shape capable of being received by said channel when said roller track guide is inserted into said channel in a direction parallel to said channel.

2. (Canceled)

3. An apparatus for transporting objects comprising:
at least one roller track having a channel on an external face; and
at least one roller track guide having a key portion that is of a shape capable of being received by said channel when said roller track guide is inserted into said channel in a direction parallel to said channel, wherein said channel is formed by a rectangular shaped portion having an opening on a side outward with respect to said roller track.

4. An apparatus for transporting objects comprising:
at least one roller track having a channel on an external face; and
at least one roller track guide having a key portion that is of a shape capable of being received by said channel when said roller track guide is inserted into said channel in a direction parallel to said channel, and further comprising, for each roller track:
two nylon carriers, each of said two nylon carrier being inserted into another channel on an inside surface of said roller track; and
at least one roller, each of said at lest one rollers having an axle through said roller at approximately a center of said roller, wherein each of said two nylon carriers includes an opening for receiving one end of said axle.

5. The apparatus of claim 4, wherein said opening is one of: a hole through said nylon carrier, and an opening partially through a surface of said nylon carrier.

6. The apparatus of claim 1, comprising an arrangement of roller tracks and roller track guides for transporting “n” rows of objects, said arrangement consisting of “n+1” roller track guides.

7. The apparatus of claim 6, wherein said key portion is formed at an end of a bottom layer of said roller track guide, said key portion including a top cut and a bottom cut, respectively, in a top and bottom surface of said bottom layer.

8. The apparatus of claim 7, wherein each roller track guide that is not located at an end position is used as a guide for rows located both of its sides.

9. The apparatus of claim 8, wherein two roller track guides are used to guide the flow of objects for each row.

10. The apparatus of claim 9, wherein each row utilizes two roller tracks.

11. The apparatus of claim 10, wherein all roller tracks and roller track guides are held in a relatively stationary position within a support system such that said roller tracks and roller track guides are positioned a vertical distance above a surface.

12. The apparatus of claim 11, wherein said support system includes a horizontal support surface joined with at least four vertical posts.

13.-14. (Cancelled)

15. A method of building an apparatus for transporting “n” rows of objects comprising:
inserting at least one roller track guide into a channel included in a face of a roller track, each of said “n” rows having at least one corresponding roller track; and
arranging a plurality of roller tracks and roller track guides using “n+1” roller track guides such that each roller track guide that is not located at an end of said arrangement is used as a guide for rows on both sides of said guide.

16. The method of claim 15, further comprising:
securing said roller tracks and said roller track guides in a support structure
